(19) United States
(12) Patent Application Publication
(10) Pub. No.: US 2008/0053682 A1
(43) Pub. Date: Mar. 6, 2008

(54) Cable Structure

(76) Inventor: Jay Victor, Redondo Beach, CA (US)

Correspondence Address: TROJAN LAW OFFICES, 9250 WILSHIRE BLVD, SUITE 325, BEVERLY HILLS, CA, 90212, US

(21) Appl. No.: 11/933,982

(22) Filed: Nov. 1, 2007

Related U.S. Application Data
(63) Continuation-in-part of application No. 11/464,144, filed on Aug. 11, 2006.
Application No. 11/464,144 is a continuation of application No. 11/287,813, filed on Nov. 28, 2005, now Pat. No. 7,091,420.
Application No. 11/287,813 is a continuation of application No. 10/619,441, filed on Jul. 16, 2003, now Pat. No. 6,969,805.

(51) Int. Cl. H01B 7/00

(52) U.S. Cl. 174/110 R

(57) ABSTRACT

A cable having multiple conductors suitable for wide frequency range applications. A cable contains conductors that are parallely arrayed and surrounded by a common insulation. At least two of the conductors are different types of conductors. They may be different in structure, shape, size, material, or any combination thereof.

### PRIORITY CLAIM

This is a continuation-in-part of and claims the benefit of priority from co-pending U.S. patent application Ser. No. 11/464,144, filed Aug. 11, 2006, which is a continuation of and claims the benefit of priority from U.S. patent application Ser. No. 11/287,813, filed Nov. 28, 2005, now U.S. Pat. No. 7,091,420, which is a continuation of and claims the benefit of priority from U.S. patent application Ser. No. 10/619,441, filed Jul. 16, 2003, now U.S. Pat. No. 6,969,805, the full disclosures of which are incorporated herein by reference.

### BACKGROUND OF THE INVENTION

1. Field of the Invention

The invention herein relates to a cable, specifically an improved structure cable suitable for full frequency range applications.

2. Description of the Prior Art

It is generally desirable for a cable carrying an electric signal or carrying AC power to provide as wide a frequency range as possible. In particular, signal transmission requirements have become higher because of the greater fidelity and sensitivity of currently available high fidelity audio system equipment. However, the signal cables utilized to convey alphanumeric pulse or audio frequency provide alternating current signals involving transmission principles that are much more complex than that of direct current transmission. In addition to the resistance encountered by electricity flowing through the conductors and the generation of a magnetic field, there is skin effect occurring between high and low frequencies as well as phase distortion. To transmit a signal via a conductor at a balanced and total true-fidelity, acoustic frequency range (20 Hz to 20 kHz or wider), the design of the cable is extremely painstaking. Only this way can an amplified signal sound like the original when replayed through a loudspeaker.

Good signal cables should support fine dynamics, separation, and rich overtones as well as presence and musicality, but most importantly, it must have a very high degree of balance. Since balance is the most essential factor of high fidelity acoustics, when full-range balance is poor, this results in various problems. For example, insufficient bass makes people feel that music is muted and diluted. Conversely, when bass is excessive, sound becomes too dense and even burdensome. Sound becomes cold when midrange is lacking and overly warm when too much is heard. At the same time, overall definition is decreased, resulting in acoustic dispersion, sound alteration, and positional inaccuracy problems. When treble projection is inadequate, music becomes depressive, monotonous, and spatially confined, while the reverse situation results in a presentation that is too bright and lively. Interfacing robust cabling with other equipment involves a certain degree of difficulty; in conventional signal cables, skin effect is a challenging problem in that it is a common cause of distortion and adversely affects signal transmission.

### SUMMARY OF THE INVENTION

The objective of the invention herein is to provide a full frequency range, improved cable structure.

To achieve the objective, a cable comprises at least two different types of conductors that are arrayed and placed into a surrounding insulation. Each conductor can be constructed of any suitable metallic material such as solid copper or multi-stranded copper wire, copper clad aluminum, copper clad aluminum/magnesium, metal-based coatings containing silver, aluminum, iron, and other metals as well as alloys and other different formulations; each conductor can also be a non-metallic compound having conductive properties. Each conductor may be a stranded, solid, magnet wire, or tinsel wire conductor. Each conductor may be of a circular or a flat, thin shape. Two or more conductors may have different diameters or sizes. Different types of conductors may be disposed in unequal quantities.

### BRIEF DESCRIPTION OF THE DRAWINGS

FIG. 1 is a cross-sectional drawing of the structure of an embodiment of the invention herein.

FIG. 2 is a cross-sectional drawing of another embodiment of the invention herein.

### DETAILED DESCRIPTION OF THE INVENTION

A cable may be constructed using various combinations of conductors that are different in structure, shape, size, material, or any combinations thereof.

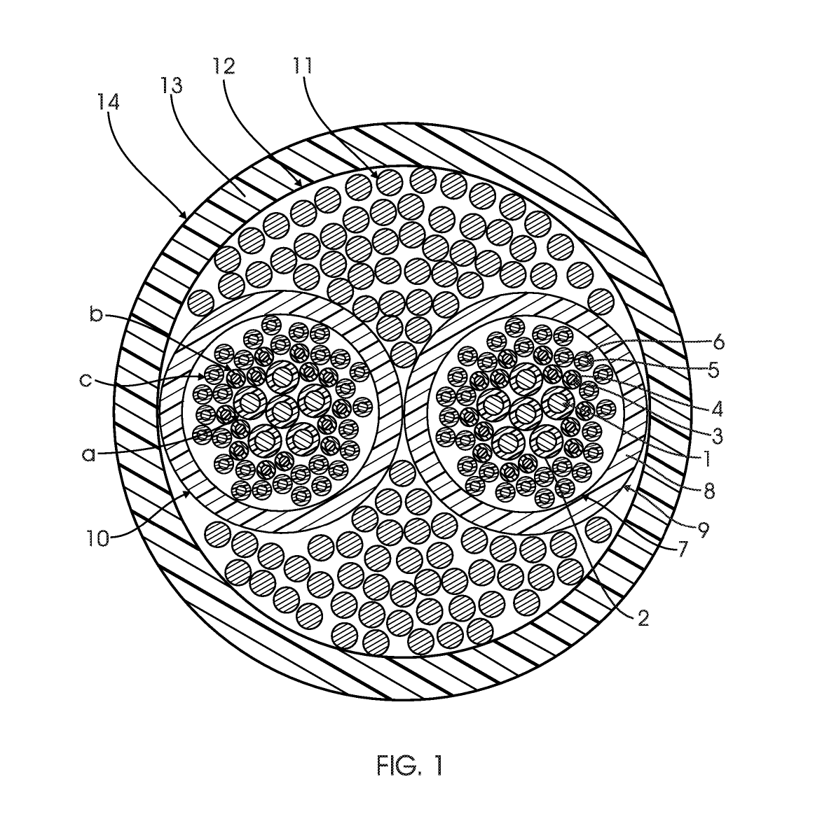

Referring to FIG. 1, larger solid conductors 1 and their insulation 2 comprise cable a, smaller solid conductors 3 and their insulation 4 comprise cable b and tinsel wire 5 and their insulation 6 comprise cable c; after the cables a, b and c of differing quantity and size are bundled into a multiple core conduit 7, an insulation 8 is placed around the outer extent of the multiple core conduit 7 to form a multiple core cable 9 and 10, filler elements 11 are disposed laterally along the multiple core cables 9 and 10 to form a multiple core composite cable 12, following which insulation 13 is placed around the multiple core composite cable 12 to complete the first embodiment cable 14 of the invention herein.

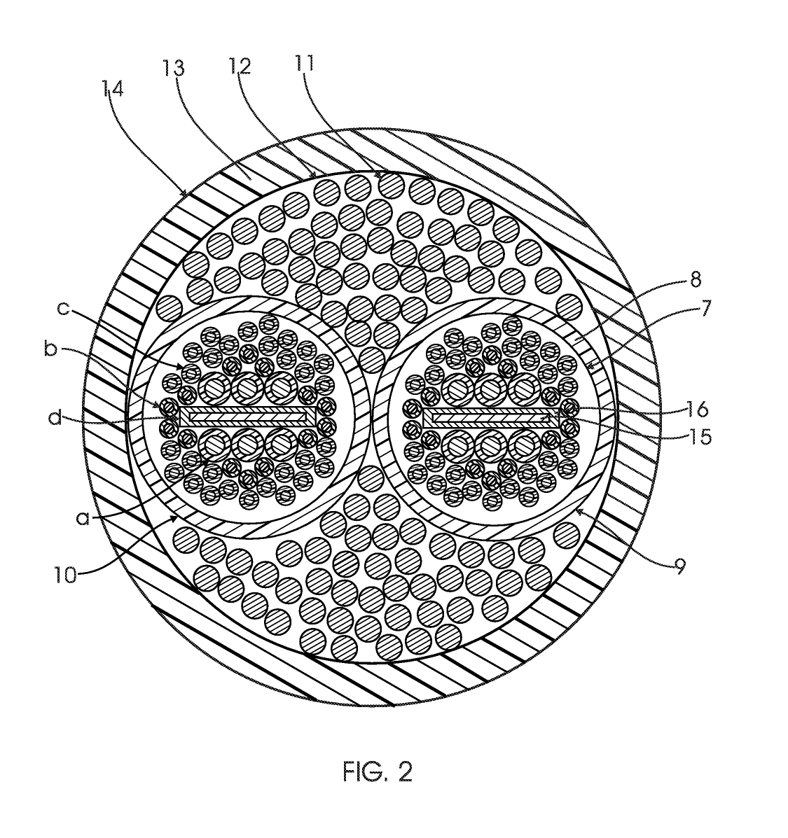

Referring to FIG. 2, the cross-sectional drawing of another embodiment of the invention herein, this variation is based on the first embodiment of the invention herein and additionally includes a thin, flat conductor 15 that is cross-sectionally rectangular which becomes a cable following the placement of insulation 16 around it; after the cables a, b, c, and d of differing quantity and size are bundled into a multiple core conduit 7, an insulation 8 is placed around the outer extent of the multiple core conduit 7 to form the multiple core cables 9 and 10, filler elements 11 are disposed laterally along the multiple core cables 9 and 10 to complete a multiple core composite cable 12, following which an insulation 13 placed around the multiple core composite cable 12 to complete the second embodiment cable 14 of the invention herein.

The said conductor refers to any conductive material; conductive wires are typically available in range of certain metals, but can be constructed of any suitable metallic material such as solid copper or multi-stranded copper wire, copper clad aluminum, copper clad aluminum/magnesium, metal-based coatings containing silver, aluminum, iron, and other metals as well as alloys and other different formulations; the conductor can also be a non-metallic compound having conductive properties. A cable may comprise different types of conductors.

The conductors may be stranded, solid, magnet wire, tinsel wire, or any combinations thereof. The conductors may be of a circular and a flat, thin shape as well as differing larger and smaller diameters and, furthermore, disposed in unequal quantities.

As an example of a cable constructed using various combinations of conductors, a cable may comprise a conductor made of copper clad aluminum, a conductor made of copper clad aluminum/magnesium, a copper stranded conductor, and a solid copper conductor, or any combinations of these conductors. Of course, any other combinations of these and other conductors are also possible.

The said insulation, also known as a dielectric, refers to a material suitable for cable insulation such as polyethylene, polypropylene, fluoropolymer, cross-linked polyethylene, rubber, and other similar materials; many insulation materials also contain more than one type of additive such as a flame retardant agent and a mildew-proofing agent.

The said larger solid conductors 1 and smaller solid connectors 3 have physical diameters that are determined through actual testing; in the embodiments herein, the diameter of the larger solid conductors 1 is two times that of the smaller solid conductors 3.

The multiple core cables of the embodiments of the invention herein can be used for carrying AC power or an electric signal. The multiple core cable may be an AC power cable, audio cable, video cable, or any electrical signal cable. The multiple core cables of the embodiments of the invention herein comprise a plurality of parallel, separate, and insulated conductors, wherein the cables are thin and light and most importantly have exceptionally low inductance and capacitance to convey tone color clearly and accurately. The acoustic characteristics of the thin, flat conductor include clarity, high definition, rich detail, tighter low frequency response, and enhanced live cables; furthermore, the insulating of each conductor prevents interference between different conductors, thereby avoiding distortion losses in the original signal.

In constructing a cable using varying combinations of different conductors, the different conductor types handle specific frequency ranges differently and can be combined and optimized size, number and type for best performance in various applications. A unique cable type has been invented using combinations of the different conductor types. The tinsel wire is constructed with special core and dielectric materials for further optimization, and it minimizes sonic degradation caused by skin effect, thus yielding better high frequency performance. Because low frequencies are compromised with tinsel wire, solid bass conductors are used, thus balancing the frequency response. Flat conductors also handle midrange frequencies with greater accuracy. Specifically selected round conductor gauges are also used for the midrange to give proper balance between the bass and treble spectrums. Different gauge round conductors appear to emphasize particular frequency ranges, and can be selected to flatten frequency balance. The unique combination of tinsel wire and selected round and flat solid conductors gives better full range frequency balance and sound quality. The composite construction yields superior frequency balance and response accuracy than can be obtained by using constructions consisting of only one conductor type. The reasons for this are not clearly understood, but it appears that the different types of conductors are superior in certain frequency ranges. By combining conductors that each appear to be superior in the treble range, the bass range, and the midrange, a superior full range cable results.

While the said detailed description elaborates workable embodiments of the improved structure of a cable herein, the said embodiments shall not be construed as a limitation on the patented scope and claims of the present invention and, furthermore, all equivalent adaptations and modifications based on the technological spirit of the present invention shall remain protected within the scope and claims of the invention herein.

What is claimed is:

1. A cable comprising multiple conductors, the conductors being parallely arrayed and surrounded by a common insulation, wherein at least two of the conductors are different types of conductors.

2. The cable of claim 1, wherein at least two of the conductors are different in shape.

3. The cable of claim 1, wherein at least two of the conductors are made of different materials.

4. The cable of claim 1, wherein at least one conductor is circular in shape.

5. The cable of claim 1, wherein at least one conductor is a tinsel wire conductor.

6. The cable of claim 1, wherein at least one conductor is flat in shape.

7. The cable of claim 1, wherein at least one conductor is a stranded wire conductor.

8. The cable of claim 1, wherein at least one conductor is a magnet wire conductor.

9. The cable of claim 1, wherein at least one conductor is made of copper clad aluminum.

10. The cable of claim 9, wherein at least one conductor is a copper stranded conductor.

11. The cable of claim 9, wherein at least one conductor is a solid copper conductor.

12. The cable of claim 1, wherein at least one conductor is made of copper clad aluminum/magnesium.

13. The cable of claim 12, wherein at least one conductor is a copper stranded conductor.

14. The cable of claim 12, wherein at least one conductor is a solid copper conductor.

15. The cable of claim 1, wherein at least one conductor is a solid conductor.

16. The cable of claim 1, wherein the cable is an AC power cable.

17. The cable of claim 1, wherein the cable is an electrical signal cable.

18. The cable of clam 1, wherein the cable is an audio cable.

19. The cable of claim 1, wherein the cable is a video cable.

20. A cable comprising multiple conductors, the conductors being parallely arrayed and surrounded by a common insulation, the conductors comprising at least two different types of conductors, wherein the conductors are different in shape.
